(19) United States
(12) Patent Application Publication
(10) Pub. No.: US 2005/0213866 A1
(43) Pub. Date: Sep. 29, 2005

(54) System

(76) Inventor: Graham Cross, Stockton-on-Tees (GB)

Correspondence Address: Daniel P McCarthy;Parsons Behle & Latimer, 201 South Main Street Suite 1800, PO Box 45898, Salt Lake City, UT, 84145-0898, US

(21) Appl. No.: 10/477,841

(22) PCT Filed: Apr. 17, 2002
(86) PCT No.: PCT/GB02/01699

§ 371 Date: May 2, 2005

(30) Foreign Application Priority Data
May 17, 2001 (GB) 0112046.8

(51) Int. Cl. G02B 6/00

(52) U.S. Cl. 385/12

(57) ABSTRACT

The present invention relates to a system for monitoring the wavelength of electromagnetic radiation including a plurality of waveguides (e.g. planar waveguides) assembled into a laminate structure and to an assembly incorporating the system together with a source of the electromagnetic radiation such as in a multiplexer (e.g. a dense wavelength division multiplexer).

### CROSS REFERENCE TO RELATED APPLICATIONS

This application is an application filed under 35 U.S.C. 371 from Application filed under the Patent Cooperation Treaty, Application No. PCT/GB02/0011699, International Filing Date: 17 Apr. 2002, and claims priority from United Kingdom Patent Application No. 0112046.8, filed 17 May 2001.

### FEDERAL RESEARCH STATEMENT

(Not applicable)

### BACKGROUND OF INVENTION

The present invention relates to a system for monitoring the wavelength of electromagnetic radiation including a plurality of waveguides (e.g. planar waveguides) assembled into a laminate structure and to an assembly incorporating the system together with a source of the electromagnetic radiation such as in a multiplexer (e.g. a dense wavelength division multiplexer).

With the deployment of dense wavelength division multiplexing (DWDM) in the optical fibre communications network there is an increasing requirement for measurement, calibration and stabilisation of the wavelength channels used. The spacing between channels is becoming increasingly narrow. In the telecommunications “C” band (for example), there is a move towards 50 GHz spacing of the channels (approximately 0.4 nm around 1550 nm). These densely spaced wavelength channels may be multiplexed with other more widely spaced wavelength channels such as a channel at 1300 nm and further DWDM channels extending from 1620 nm towards 1485 nm are expected in the future.

Lasers must remain frequency stabilised. These require a feedback loop that can provide an error signal to the tuning circuit when the frequency strays. In conventional systems, this may be achieved by placing the laser adjacent to a Fabry Perot cavity of the appropriate length. If the output wavelength fluctuates, a photodiode monitors a change in transmitted power and adjusts the wavelength accordingly to restore the original power. A disadvantage of this system is that the laser output power may itself fluctuate giving false indications of wavelength shift.

Commercial assemblies that can monitor the wavelength of a laser diode with an accuracy of ±0.0003 nm (0.3 pm) are available (Burleigh Instruments) but these are designed to calibrate lasers during manufacture and to monitor wavelengths on an optical fibre circuit. There is a facility to track changes in the output wavelength of laser sources with updates to this information every second. However these instruments cost around £25,000 and are impractical for wider implementation in the telecommunications network.

Integrated optical assemblies that spatially resolve individual wavelengths of light have been widely described. These generally involve the use of diffraction grating structures patterned onto the optical substrate. Such assemblies can be used to analyse the spectral content of the input beam (see U.S. Pat. No. 6,016,197; U.S. Pat. No. 4,761,048; U.S. Pat. No. 5,066,126; DE-A-4420074; DE-A-4209672; Takada, IEEE Phot. Tech. Lett., 11, 863, (1999); Tcheremiskin, Electronics Lett., 33, 1952, (1997); Masden et al, IEEE J. Selected Topics in Quant. Electr., 4, 925, (1998); Valette et al, IEEE Proc. 131, 325, (1984)). The use of optical fibers to form a source stabilizer is known (U.S. Pat. No. 5,381,230) and Kunz et al in Optics Letters, 20, 2300, (1995) have described an integrated optical wavelength analyzer chip.

Pandruad et al (J. Lightwave Tech., 17, 2336, (1999)) describe the normalised expressions that allow a designer to achieve zero dispersion difference between the two modes of a dual mode integrated optical assembly and have contributed to a report on the optimisation of dispersion in the context of a wavelength meter (Opt. Commun., 163, 278 (1999)). The latter refers to a spiral waveguide whose propagation distance of light depends on refractive index contrast between core and cladding. This effect is well known and is described in terms of bending losses. In the description of wavelength shift measurement, it is proposed that by designing the waveguide to be of high dispersion, any changes in wavelength show up as a change in propagation distance measured using outscattered light from the waveguide.

### SUMMARY OF INVENTION

The present invention seeks to improve wavelength monitoring by exploiting a waveguide structure (e.g. a planar waveguide structure) advantageously sensitive to the direction and magnitude of a wavelength shift of a source of electromagnetic radiation (e.g. a laser). More particularly, the invention relates to a system for monitoring (e.g. measuring continuously or controlling) the wavelength of incident electromagnetic radiation which is insensitive to fluctuations in the power of the electromagnetic radiation and which may be constructed at low cost with very simple packaging. The invention would be particularly suited to monolithic integration with a semiconductor diode laser.

Thus viewed from one aspect the present invention provides a system for monitoring the wavelength of incident electromagnetic radiation comprising:
a plurality of waveguides assembled into a laminate structure, said plurality of waveguides including: a first waveguide capable of exhibiting a first measurable response to a change in the wavelength of the incident electromagnetic radiation and a second waveguide capable of exhibiting a second measurable response to the change in the incident electromagnetic radiation, wherein the first measurable response is different to the second measurable response; and
a measuring means for measuring the first measurable response and/or the second measurable response or the first measurable response relative to the second measurable response.

The waveguides may be channel or planar waveguides. By “planar waveguide” is meant a waveguide which permits propagation of incident electromagnetic radiation in any arbitrary direction within a plane. Preferably the planar waveguides are slab waveguides.

Preferably the measuring means is adapted to measure the first measurable response relative to the second measurable response. Relative measurements advantageously have a lower uncertainty value than absolute measurements due to the limited precision with which the measuring means (e.g. the diode array) may be positioned.

The measuring means is preferably adapted to measure the first measurable response and/or the second measurable response or the first measurable response relative to the second measurable response in the form of an interference pattern. The interference pattern may be generated in the far field when the output electromagnetic radiation from the first and second planar waveguide is coupled into free space.

In a preferred embodiment, the dispersion characteristics (i.e. the change in the effective refractive index of the propagating mode vs. wavelength) of the first waveguide mode are of different magnitude to the dispersion characteristics of the second waveguide mode. A difference in the magnitude of the dispersion characteristics of the first and second waveguide modes leads to a difference in their response to a change in the wavelength of incident electromagnetic radiation which may be measured.

The system of the invention in this embodiment may exploit the difference in the dispersion characteristics of the first and second waveguide to provide an interference condition between two propagating modes that is sensitive to small changes in wavelength. The measurable response of the first waveguide to a change in the wavelength relative to the measurable response of the second waveguide to the change in the wavelength manifests itself as movement of the fringes in the interference pattern. Thus the measuring means is preferably adapted to measure the first measurable response relative to the second measurable response as a movement of fringes in the interference pattern.

Movement of the fringes in an interference pattern may be measured in a conventional manner (see for example WO-A-98/22807) either using a single detector which measures changes in the intensity of electromagnetic radiation or a plurality of such detectors which monitor the change occurring in a number of fringes or in the entire interference pattern. The one or more detectors may comprise one or more photodetectors. Where more than one photodetector is used this may be arranged in an array e.g. a two-dimensional photodiode array (or the like).

In a preferred embodiment, a dielectric property (e.g. the effective refractive index) of the first waveguide is of different magnitude to the dielectric property of the second waveguide. A difference in the magnitude of a dielectric property of the first and second waveguide leads to a difference in their response to a change in the wavelength of incident electromagnetic radiation (i.e. a difference in the transmission of the incident electromagnetic radiation) which may be measured.

The measuring means may be adapted to measure a change in the power of the output electromagnetic radiation of the first waveguide and/or a change in the power of the output electromagnetic radiation of the second waveguide or a change in the power of the output electromagnetic radiation of the first waveguide relative to a change in the power of the output electromagnetic radiation of the second waveguide.

An embodiment of the system of the invention further comprises:
calculating means for calculating the phase shift of the incident electromagnetic radiation in the first waveguide relative to the phase shift of the incident electromagnetic radiation in the second waveguide (“the relative phase shift”) from the movement of the fringes in the interference pattern. It will be understood that the phase shift may equally be expressed as a change in effective refractive index (and the relative phase shift as a difference in the change in effective refractive index).

The change in the wavelength of the incident electromagnetic radiation may be calculated from the relative phase shift.

In a preferred embodiment, the system of the invention further comprises: generating means for generating an adjustment signal dependent on the measured first measurable response and/or the measured second measurable response or on the measured first measurable response relative to the second measurable response (or on the phase shift or relative phase shift calculated therefrom). Particularly preferably the system further comprises: an applying means for applying the adjustment signal to the source of incident electromagnetic radiation whereby to restore the wavelength of the incident electromagnetic radiation. By incorporating the laminate structure in a feedback circuit together with the generating means and applying means, the invention may provide frequency stabilisation to the source of electromagnetic radiation to within 1 GHz or less.

The generating means may be for example a comparator for generating an adjustment signal dependent on the magnitude and/or direction of the measured first measurable response and/or the measured second measurable response or the measured first measurable response relative to the second measurable response (or the phase shift or relative phase shift calculated therefrom).

The applying means may be a temperature controller such as a thermo-optic tuning device.

The laminate structure may be generally of the multi-layered type disclosed in WO-A-98/22807. The “sensing” waveguide may be isolated from the environment by a capping layer. By assembling the plurality of waveguides into a laminate structure, the system of the invention is simple to fabricate and fault tolerant in terms of construction errors. In a preferred embodiment, each of the plurality of waveguides in the laminate structure is built onto a substrate (e.g. of silicon) through known processes such as PECVD or LPCVD. Such processes are highly repeatable and lead to accurate manufacture. Intermediate transparent layers may be added (e.g. silicon dioxide) if desired. Preferably each waveguide is fabricated to allow equal amounts of electromagnetic radiation to propagate by simultaneous excitation of the guided modes in the laminate structure. Typically the laminate structure is of a thickness in the range. 0.2-10 microns.

In order to render the dispersion characteristics of the first waveguide different to the second waveguide, the laminate structure may be fabricated with dimensional and/or compositional asymmetry. The ability to precisely tailor the dimension and/or composition of waveguides assembled into a laminate structure renders the laminate structure sensitive to wavelength changes but (due to the otherwise high compositional symmetry) insensitive to temperature fluctuations thereby advantageously simplifying the associated packaging.

Thus in an embodiment of the system of the invention the first and second waveguide differ in their composition and/or dimension (e.g. thickness). Dimensional and/or compositional asymmetry is readily achieved in accordance with familiar fabrication methods such as CVD (e.g. PECVD, LPCVD, etc). In this way (for example), the intrinsic refractive index of a silicon oxynitride planar waveguide (at a constant thickness) may be selected at any level in the range 1.457 to 2.008.

Preferably the first and second waveguide differ in their dimension (e.g. differ in their thickness).

Preferably the laminate structure is fabricated onto a silicon substrate and consists essentially of a first planar waveguide located above and spaced apart from a second planar waveguide by an intermediate silicon dioxide layer. Particularly preferably the laminate structure further consists essentially of a capping layer to isolate the first planar waveguide from the environment.

In an embodiment of the system of the invention, the first and/or second planar waveguide is composed of silicon oxynitride or silicon nitride.

In an embodiment of the system of the invention, the first and second planar waveguide are composed of compound semiconductor materials.

In a preferred embodiment, the plurality of waveguides and the measuring means are assembled onto a common substrate (typically a common silicon or indium phosphide substrate).

Viewed from a further aspect the present invention provides an assembly comprising:
an electromagnetic radiation source; and
a system as hereinbefore defined whereby the electromagnetic radiation source is adapted to propagate incident electromagnetic radiation into the first and second waveguide of the laminate structure.

Electromagnetic radiation generated from an electromagnetic radiation source such as a laser may be propagated into the laminate structure in a number of ways. In a preferred embodiment, the electromagnetic radiation source is adapted to propagate incident electromagnetic radiation into the end face of the laminate structure (this is sometimes described as “an end firing procedure”).

Preferably the electromagnetic radiation source (e.g. laser) is integrated with the laminate structure on the common substrate (typically a common silicon or indium phosphide substrate).

The assembly may further comprise propagating means for substantially simultaneously propagating incident electromagnetic radiation into the first and second waveguide. For example, one or more coupling gratings or mirrors may be used. A taper coupler rather than a coupling grating or mirror may be used to transfer incident electromagnetic radiation between the waveguides. Particularly preferably, the amount of electromagnetic radiation propagated into the first waveguide and into the second waveguide is effectively equal.

An embodiment of the assembly of the invention further comprises one or more optical fibres operatively connected to the system and to the electromagnetic source. The one or more optical fibres may be operatively connected to the system in a conventional manner (e.g. by a fibre pigtail). The one or more optical fibres may be part of an optical fibre network such as a multichannel network e.g. a multiplexing multichannel network such as a dense wavelength division multiplexing multichannel network (e.g. in an optical fibre communications network).

The assembly may further comprise polarising means for orienting (e.g. plane polarising) the incident electromagnetic radiation. The assembly may further comprise a lens or similar micro-focussing means for focussing the incident electromagnetic radiation.

Both the TE (transverse electric) and the TM (transverse magnetic) excitation modes may be used sequentially to excite the laminate structure. In this sense, the assembly further comprises: a first electromagnetic radiation source for propagating TM mode electromagnetic radiation into the first and second waveguide and a second electromagnetic radiation source for propagating TE mode electromagnetic radiation into the first and second waveguide.

Viewed from a still further aspect the present invention provides an optical fibre network incorporating one or more assemblies as hereinbefore defined. Preferably the optical fibre network is an optical fibre communications network. Preferably the optical fibre network is a multichannel network e.g. a multiplexing multichannel network such as a dense wavelength division multiplexing multichannel network.

The integration of the components of the system or assembly of the invention into existing networks is within the capability of the skilled man. For example, in the telecommunications industry, lasers are frequently integrated onto indium phoshpide substrates and it is a straightforward matter to integrate thereon components of the system of the invention. For example, the planar waveguides of the laminate structure may be grown in situ using for example known techniques such as MOCVD techniques.

Viewed from a yet further aspect the present invention provides a method for monitoring the wavelength of electromagnetic radiation comprising:
(A) providing a system as hereinbefore defined;
(B) propagating electromagnetic radiation of a first wavelength into the first waveguide and the second waveguide in the laminate structure;
(C) measuring a first measurable response and/or a second measurable response or the first measurable response relative to the second measurable response; and
(D) relating the measured first measurable response and/or measured second measurable response or the measured first measurable response relative to the second measurable response to a change in the wavelength of the electromagnetic radiation from the first wavelength to a second wavelength.

In a preferred embodiment, step (C) comprises: measuring a first measurable response relative to a second measurable response. Relative measurements advantageously have a lower uncertainty value than absolute measurements due to the limited precision with which a measuring means (e.g. the diode array) may be positioned.

In a preferred embodiment, step (C) comprises:
(C1) generating a pattern of interference fringes; and
(C2) measuring a movement in the interference fringes; and step (D) comprises:
relating the movement in the interference pattern to a change in the wavelength of the electromagnetic radiation from the first wavelength to a second wavelength.

In a particularly preferred embodiment, step (C) further comprises: (C3) calculating the phase shift in the first waveguide relative to the phase shift in the second waveguide (“the relative phase shift”) from the movement in the interference fringes;

and step (D) comprises:

relating the relative phase shift to the change in the wavelength of electromagnetic radiation from a first wavelength to a second wavelength.

In a particularly preferred embodiment, step (D) comprises:
(E) generating an adjustment signal dependent on the movement in the interference pattern measured in step C2 (or the relative phase shift calculated in step C3);
(F) applying the adjustment signal to the source of electromagnetic radiation whereby to adjust the wavelength of the electromagnetic radiation from the second wavelength to the first wavelength.

Step (E) may be carried out by a comparator which generates an adjustment signal dependent on the magnitude and/or direction of the movement in the interference pattern (or preferably of the relative phase shift).

Step (F) may be carried out thermo-optically. For example, a conventional temperature controller may be used to thermo-optically tune the source of electromagnetic radiation. Step (F) may be carried out by adjusting the electromagnetic radiation source current using (for example) a tuning element such as a tunable filter (e.g. Bragg grating filter).

In an embodiment of the invention, step (D) comprises: deducing the wavelength shift from the measured first measurable response and/or measured second measurable response or the measured first measurable response relative to the second measurable response.

In a preferred embodiment, step (B) comprises: propagating TM mode electromagnetic radiation of a first wavelength into the first waveguide and the second waveguide and/or propagating TE mode electromagnetic radiation of a first wavelength into the first waveguide and the second waveguide.

Viewed from a yet still further aspect the present invention provides the use of a plurality of waveguides (e.g. planar waveguides) assembled into a laminate structure for monitoring the wavelength of electromagnetic radiation, said plurality of waveguides including: a first waveguide capable of exhibiting a first measurable response to a change in the wavelength of the incident electromagnetic radiation and a second waveguide capable of exhibiting a second measurable response to the change in the incident electromagnetic radiation, wherein the first measurable response is different to the second measurable response.

The system of the invention may also be used to monitor changes in the power of incident electromagnetic radiation and (if desired) restore the power to an original level.

Thus viewed from an even still further aspect the present invention provides a method for monitoring the power of incident electromagnetic radiation comprising:
(A) providing a system as hereinbefore defined;
(B) propagating electromagnetic radiation of a first power into the first waveguide and the second waveguide in the laminate structure;
(C) measuring a change in the power of the output electromagnetic radiation of the first waveguide and/or a change in the power of the output electromagnetic radiation of the second waveguide or the change in the power of the output electromagnetic radiation of the first waveguide relative to the change in the power of the output electromagnetic radiation of the second waveguide; and
(D) relating the change in the power of the output electromagnetic radiation of the first waveguide and/or the change in the power of the output electromagnetic radiation of the second waveguide or the change in the power of the output electromagnetic radiation of the first waveguide relative to the change in the power of the output electromagnetic radiation of the second waveguide to a change in the power of the incident electromagnetic radiation from the first power to a second power.

In a preferred embodiment, step (D) comprises:
(E) generating an adjustment signal dependent on the measurements made in step (C);
(F) applying the adjustment signal to the source of incident electromagnetic radiation whereby to adjust the power of the incident electromagnetic radiation from the second power to the first power.

Step (E) may be carried out by a comparator which generates an adjustment signal dependent on the magnitude and/or direction of the change in the power of the output electromagnetic radiation (or preferably of the relative change in the power of the output electromagnetic radiation).

In step (F), the power of the incident electromagnetic radiation may be adjusted by changing the laser diode current.

Viewed from an even yet still further aspect the present invention provides a process for measuring the wavelength of electromagnetic radiation, said process comprising:
providing a system as hereinbefore defined;
propagating the electromagnetic radiation into the first waveguide and the second waveguide in the laminate structure;
generating a pattern of interference fringes; and
calculating the wavelength of the electromagnetic radiation from the spacing of the interference fringes.

The process of the invention may further comprise the steps of:
measuring a change in the spacing of the interference fringes and calculating the change in wavelength of the electromagnetic radiation.

Generally speaking, the spacing of interference fringes is governed by the free space wavelength of the propagating radiation and the geometrical relationship governing the spacing of the two “sources” and the distance to the measuring plane. For example, close to the image centroid, the spacing a is given approximately by the simple formula:
a=λs/d
(where λ is the free space wavelength, s is the distance between the twin source midpoint and the measuring plane and d is the transverse separation of the sources). The source separation in the assembly is governed by the design parameters of the laminate structure and can be closely controlled. The distance from the source midpoint to the measuring plane can also be accurately fixed.

The invention may be exploited for any type of electromagnetic radiation including optical, UV, IR, X-rays, microwaves.

### BRIEF DESCRIPTION OF DRAWINGS

The present invention will now be described in a non-limitative sense with reference to the accompanying Figures in which:

FIG. 1 illustrates a sectional view of first and second waveguides assembled into a laminate structure in accordance with an embodiment of the system of the invention;

FIG. 2 illustrates schematically an embodiment of the assembly of the invention; and

FIG. 3 illustrates schematically an embodiment of the assembly of the invention.

### DETAILED DESCRIPTION

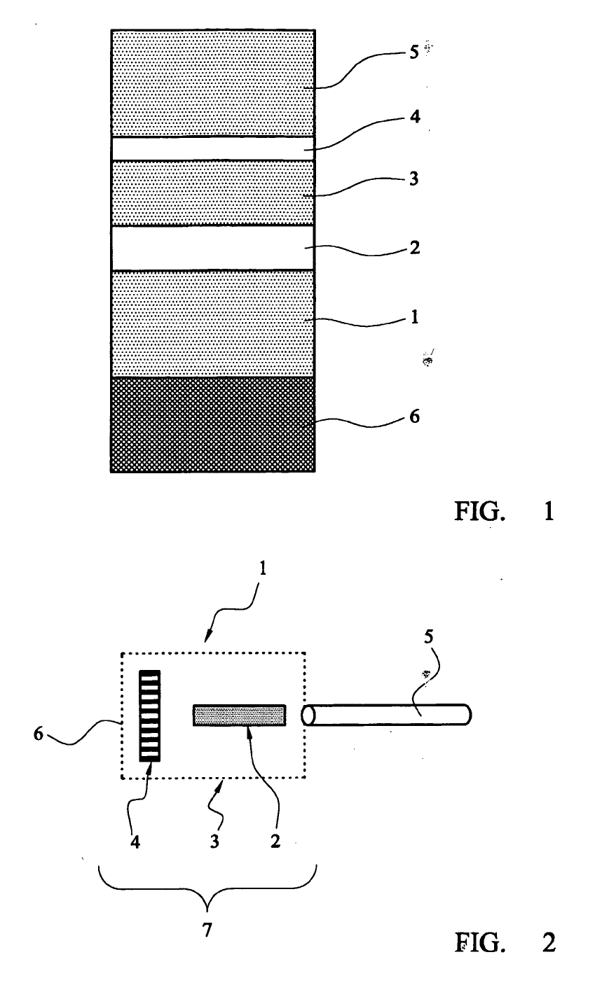

The characteristics of each of layers 1 to 5 of the laminate structure illustrated in FIG. 1 are as follows:

| | LAYER | | | | |
|---|---|---|---|---|---|
| | 1 | 2 | 3 | 4 | 5 |
| REFRACTIVE INDEX | 1.457 | 2.008 | 1.464 | 2.008 | 1.464 |
| THICKNESS (μm) | 2.5 | 0.5 | 1.5 | 0.4 | 2.5 |

The laminate structure is composed of a combination of thermal oxide, LPCVD silicon nitride and PECVD silicon dioxide. Layers 2 and 4 are composed of silicon nitride and act as first and second planar waveguides separated by a transparent silicon dioxide layer 3. The layers 2 and 4 possess the required dimensional asymmetry by virtue of their different thicknesses. Layer 5 is a capping layer isolating layer 4 from the environment. The layers 1 to 5 are built onto a silicon substrate 6.

A calculation was carried out on the laminate structure of FIG. 1 in which the wavelength of incident electromagnetic radiation was scanned across a 0.8 nm span around a central wavelength of 1.55 μm. This was intended to simulate the channel spacing of 0.4 nm in future DWDM devices (conventional systems use 0.8 nm spacing). The difference between the effective refractive index change seen in the zeroth order or first order modes is calculated for each of the TE and TM polarisation.

TE modes
|ΔTE₀−ΔTE₁=9.01E⁻⁶
TM modes
|ΔTM₀−ΔTM₁|=10.34E⁻⁶

In a system of typical length 5 mm, this would correspond to a wavelength sensitivity of approximately 228 mrad/nm for TE and 262 mrad/nm for TM. Thus the system could keep tunable sources on track very straightforwardly. If it is proposed to detect shifts of 5 mrad, a wavelength shift of 22 pm would be resolvable. Further optimisation may bring this down to the single picometer level.

FIG. 2 illustrates schematically an embodiment of the assembly of the invention designated generally by reference numeral 1 in which the laminate structure 2 is fabricated onto a silicon substrate 3 together with a photodiode array 4 to form a unit 7. The laminate structure is typically of the type described above with reference to FIG. 1. An optical fibre which is part of a network of optical fibres is operatively connected to the unit 7 by a fibre pigtail 5. The unit 7 provides electrical output 6 which may be used (for example) in a feedback loop to control the source of electromagnetic radiation as described below.

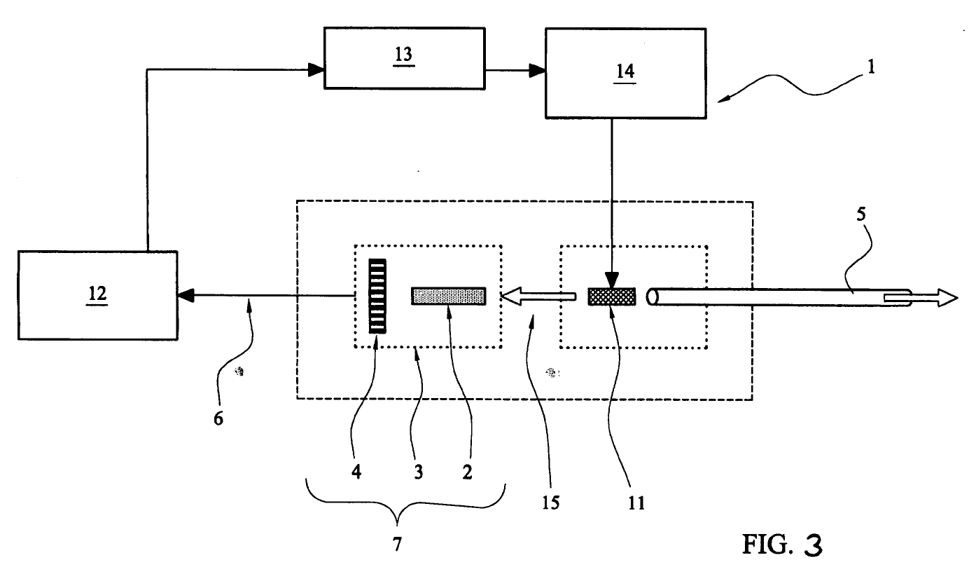

FIG. 3 illustrates schematically an embodiment of the assembly of the invention 1 in which the unit 7 described above with reference to FIG. 2 retains the same reference numerals. The assembly 1 further comprises a laser 11 providing rear facet emission of electromagnetic radiation 15. The electrical output 6 from the unit 7 is fed into a calculating means 12 which calculates a relative phase shift between the first and second planar waveguides and feeds this information to a comparator 13. The comparator 13 compares the relative phase shift with a set point and depending on the magnitude and direction of the relative phase shift feeds an adjustment signal to a temperature controller 14. The controller 14 tunes the wavelength of the laser emission so that the relative phase shift reduces until the original phase position is restored.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention. Although some embodiments are shown to include certain features, the inventors specifically contemplate that any feature disclosed herein may be used together or in combination with any other feature on any embodiment of the invention. It is also contemplated that any feature may be specifically excluded from any embodiment of an invention.

1. A system for monitoring the wavelength of incident electromagnetic radiation comprising:
a plurality of waveguides assembled into a laminate structure, said plurality of waveguides including: a first waveguide capable of exhibiting a first measurable response to a change in the wavelength of the incident electromagnetic radiation and a second waveguide capable of exhibiting a second measurable response to the change in the incident electromagnetic radiation, wherein the first measurable response is different to the second measurable response; and
a measuring means for measuring the first measurable response and/or the second measurable response or the first measurable response relative to the second measurable response.

2. A system as claimed in claim 1 comprising:
a plurality of planar waveguides assembled into a laminate structure, said plurality of planar waveguides including: a first planar waveguide capable of exhibiting a first measurable response to a change in the wavelength of the incident electromagnetic radiation and a second planar waveguide capable of exhibiting a second measurable response to the change in the incident electromagnetic radiation, wherein the first measurable response is different to the second measurable response.

3. A system as claimed in claim 2 wherein each planar waveguide is a slab waveguide.

4. A system as claimed in claim 1 wherein the measuring means is adapted to measure the first measurable response relative to the second measurable response.

5. A system as claimed in claim 1 wherein the dispersion characteristics of the first waveguide are of different magnitude to the dispersion characteristics of the second waveguide.

6. A system as claimed in claim 1 wherein a dielectric property of the first waveguide is of different magnitude to the dielectric property of the second waveguide.

7. A system as claimed in claim 1 wherein the measuring means is adapted to measure the first measurable response relative to the second measurable response as a movement of fringes in an interference pattern.

8. A system as claimed in claim 1 wherein the measuring means is adapted to measure a change in the power of the output electromagnetic radiation of the first waveguide and/or a change in the power of the output electromagnetic radiation of the second waveguide or a change in the power of the output electromagnetic radiation of the first waveguide relative to a change in the power of the output electromagnetic radiation of the second waveguide.

9. A system as claimed in claim 1 further comprising:
generating means for generating an adjustment signal dependent on the measured first measurable response and/or the measured second measurable response or on the measured first measurable response relative to the second measurable response

10. A system as claimed in claim 9 further comprising:
an applying means for applying the adjustment signal to the source of incident electromagnetic radiation whereby to restore the wavelength of the incident electromagnetic radiation.

11. A system as claimed in claim 10 wherein the applying means is a temperature controller or a tunable filter element.

12. A system as claimed in claim 1 wherein the laminate structure is fabricated with dimensional and/or compositional asymmetry so as to render the dispersion characteristics of the first waveguide different to the second waveguide.

13. A system as claimed in claim 12 wherein the first and second waveguide differ in their composition and/or dimension.

14. A system as claimed in claim 13 wherein the first and second waveguide differ in their thickness.

15. A system as claimed in claim 1 wherein the plurality of waveguides and the measuring means are assembled onto a common substrate.

16. An assembly comprising:
an electromagnetic radiation source; and
a system as defined in claim 1
whereby the electromagnetic radiation source is adapted to propagate incident electromagnetic radiation into the first and second waveguide of the laminate structure.

17. An assembly as claimed in claim 16 further comprising:
one or more optical fibres operatively connected to the system and to the electromagnetic source.

18. An assembly as claimed in claim 17 wherein the one or more optical fibres are operatively connected to the system by a fibre pigtail.

19. An assembly as claimed in claim 17 wherein the one or more optical fibres are part of an optical fibre network.

20. An assembly as claimed in claim 19 wherein the optical fibre network is a multichannel network.

21. An assembly as claimed in claim 19 wherein the optical fibre network is a multiplexing multichannel network

22. An assembly as claimed in 21 wherein the multiplexing multichannel network is a dense wavelength division multiplexing multichannel network.

23. An optical fibre network incorporating one or more assemblies as defined in claim 16.

24. An optical fibre network as claimed in claim 23 being an optical fibre communications network.

25. An optical fibre network as claimed in claim 23 being a multichannel network.

26. An optical fibre network as claimed in claim 25 being a multiplexing multichannel network.

27. An optical fibre network as claimed in claim 26 being a dense wavelength division multiplexing multichannel network.

28. A method for monitoring the wavelength of electromagnetic radiation comprising:
(A) providing a system as defined in claim 1;
(B) propagating electromagnetic radiation of a first wavelength into the first waveguide and the second waveguide in the laminate structure;
(C) measuring a first measurable response and/or a second measurable response or the first measurable response relative to the second measurable response; and
(D) relating the measured first measurable response and/or measured second measurable response or the measured first measurable response relative to the second measurable response to a change in the wavelength of the electromagnetic radiation from the first wavelength to a second wavelength.

29. A method as claimed in claim 28 wherein step (C) comprises:
measuring a first measurable response relative to a second measurable response.

30. A method as claimed in claim 28 wherein step (C) comprises:
(C1) generating a pattern of interference fringes; and
(C2) measuring a movement in the interference fringes;
and step (D) comprises:
relating the movement in the interference pattern to a change in the wavelength of the electromagnetic radiation from the first wavelength to the second wavelength.

31. A method as claimed in claim 30 wherein step (C) further comprises:
(C3) calculating the phase shift in the first waveguide relative to the phase shift in the second waveguide from the movement in the interference fringes;
and step (D) comprises:
relating the relative phase shift to the change in the wavelength of electromagnetic radiation from the first wavelength to the second wavelength.

32. A method as claimed in claim 30 wherein step (D) comprises:
(E) generating an adjustment signal dependent on the movement in the interference pattern measured in step C2;
(F) applying the adjustment signal to the source of electromagnetic radiation whereby to adjust the wavelength of the electromagnetic radiation from the second wavelength to the first wavelength.

33. A method as claimed in claim 32 wherein step (F) is carried out thermo-optically or using a tunable Bragg grating filter.

34. A method as claimed in claim 28 wherein step (B) comprises:
propagating TM mode electromagnetic radiation of a first wavelength into the first waveguide and the second waveguide and/or propagating TE mode electromagnetic radiation of a first wavelength into the first waveguide and the second waveguide.

35. A method for monitoring the power of incident electromagnetic radiation comprising:
(A) providing a system as defined in claim 1;
(B) propagating electromagnetic radiation of a first power into the first waveguide and the second waveguide in the laminate structure;
(C) measuring a change in the power of the output electromagnetic radiation of the first waveguide and/or a change in the power of the output electromagnetic radiation of the second waveguide or the change in the power of the output electromagnetic radiation of the first waveguide relative to the change in the power of the output electromagnetic radiation of the second waveguide; and
(D) relating the change in the power of the output electromagnetic radiation of the first waveguide and/or the change in the power of the output electromagnetic radiation of the second waveguide or the change in the power of the output electromagnetic radiation of the first waveguide relative to the change in the power of the output electromagnetic radiation of the second waveguide to a change in the power of the incident electromagnetic radiation from the first power to a second power.

36. A method as claimed in claim 35 wherein step (D) comprises:
(E) generating an adjustment signal dependent on the measurements made in step (C);
(F) applying the adjustment signal to the source of incident electromagnetic radiation whereby to adjust the power of the incident electromagnetic radiation from the second power to the first power.

37. A process for measuring the wavelength of electromagnetic radiation, said process comprising:
providing a system as defined in claim 1;
propagating the electromagnetic radiation into the first waveguide and the second waveguide in the laminate structure;
generating a pattern of interference fringes; and
calculating the wavelength of the electromagnetic radiation from the spacing of the interference fringes.

38. A process as claimed in claim 37 further comprising the steps of:
measuring a change in the spacing of the interference fringes; and
calculating the change in wavelength of the electromagnetic radiation.
